(19) United States
(12) Patent Application Publication
(10) Pub. No.: US 2004/0229119 A1
(43) Pub. Date: Nov. 18, 2004

(54) Battery casing structure adapting different battery specifications

(75) Inventors: Mao-Ju Lin, Taipei (TW); Ming-Yuan Liu, Taipei (TW)

Correspondence Address: BACON & THOMAS, PLLC, 625 SLATERS LANE, FOURTH FLOOR, ALEXANDRIA, VA, 22314

(73) Assignee: INVENTEC CORPORATION, Taipei (TW)

(21) Appl. No.: 10/437,082

(22) Filed: May 14, 2003

(51) Int. Cl. H01M 2/02

(52) U.S. Cl. 429/164

(57) ABSTRACT

The present invention discloses a battery casing structure adapting different battery specifications, not only can solve the temporary power problem, but also can sheathe batteries of different specifications (such as No. 2 Size C battery and No. 3 Size AA battery, No. 1 Size D . . . etc) into its main body and cover to avoid direct corrosion to the electronic components in the electric appliance or equipment when a leakage of chemical solution occurs. The present invention can isolate the chemical solution leaked from the battery within the battery casing with the features of low cost, easy operation, and outstanding performance.

### BACKGROUND OF THE INVENTION

1. Field of the Invention

The present invention relates to a battery casing structure, more particularly to a battery casing capable of adapting different battery specifications.

2. Description of the Related Art

In recent years, electronic and communications technologies advance in a large fold, and various electric appliances or equipments (such as the automatic ignition and water supply heater or flash light, etc) derived from such technologies are developed rapidly, not only bringing convenience to us, but also being an indispensable part to our life. As different kinds of electric equipments are introduced unceasingly, more and more people are using electric appliances or equipments, but all these electric appliances or equipments require at least one battery for the power supply as required for the operation of these electric appliances or equipments.

However, there are 5 common kinds of batteries currently sold in the market, and they are divided according to their specifications: No. 1 Size D battery, No. 2 Size C battery, No. 3 Size AA battery, No. 4 Size AAA battery, and No. 5 Size N battery. All of these five kinds of batteries provide a nominal voltage of 1.5 volts.

The volume, length, and diameter of the foregoing 5 kinds of batteries are different. Therefore, these batteries cannot be shared in the same electric appliance or equipment; for example, when a user is using the No. 1 Size D battery for an automatic ignition water supply heater or flash light, the user cannot use the No. 2 Size C battery, No. 3 Size AA, or No. 4 Size AAA batteries with different volumes, lengths, and diameters. It often causes inconvenience to users, because it wastes time to buy the battery of an appropriate specification or seek a temporary substitute battery everywhere, and sometimes we cannot even find the correct substitutes. Therefore, the traditional battery casing is unable to solve the problem of the urgent use of such electric appliance and equipment. Obviously, the application of this type is inconvenient and has limitations. Such arrangement definitely goes in a direction opposite to the development trend of all-purpose and multifunctional products.

Therefore, if a battery casing structure capable of adapting batteries of different specifications is designed to solve the foregoing problems for the required temporary power, it will enhance the utility of the batteries. In the meantime, such arrangement is a big advancement and a breakthrough of the design to match up with the present severe competition in the electronic and communications markets and meet consumer's requirements, and thus such invention will be beneficial to our society.

In view of the shortcomings of the foregoing batteries with different specifications that cannot be used in the same electric appliance or equipment and may cause inconvenience to users and limitations to applications, the inventor of the present invention based on years of experience accumulated from the engagement in the battery related industry and conducted extensive research to overcome the aforementioned shortcomings and finally invented the “Battery casing structure adapting different battery specifications” according to the present invention The present invention not only shares batteries of different specifications, but also offers low cost, easy operation, and outstanding performance. In the meantime, the present invention also can provide the need for temporary electric power and attain the utility of the application.

### SUMMARY OF THE INVENTION

The primary objective of the present invention is to provide a battery casing structure adapting different specifications that comprises a main body and a cover being coupled to the main body to form a battery casing with the size equal to a No. 1 Size D battery. The internal diameter of the battery casing can exactly accommodate a battery of different specifications and use it as the No. 1 Size D battery. An electric contact point is disposed on the inner wall at one end of the main body, and the electric contact point is coupled to an anode exposed on the outer wall. An electric contact point is disposed on the inner wall at another end of the cover, and the electric contact point is coupled to a cathode of its outer wall such that the anode and cathode contact points are used for the electric connection for the electric appliance or equipment.

Another objective of the present invention is to provide a battery casing structure that can use a No. 3 Size AA battery as a No. 1 Size D battery by installing a first cylindrical battery compartment into such battery casing and directly installing the No. 3 Size AA battery into such first cylindrical battery compartment and use it as the No. 1 Size D battery.

A further objective of the present invention is to provide a battery casing structure that can use a No. 4 Size AAA battery as a No. 1 Size D battery by installing a second cylindrical battery compartment into such battery casing and directly installing the No. 4 Size AAA battery into such second cylindrical battery compartment and use it as the No. 1 Size D battery. By means of such arrangement, the battery casing can share batteries of different specifications and apply different batteries on the electric appliance or equipment using the No. 1 battery specification. Such structure not only effectively solves the temporary electric power problem, but also avoids corroding the electronic components in the electric appliance or equipment directly when a leakage of chemical solution (electrolyte) occurs.

### BRIEF DESCRIPTION OF THE DRAWINGS

Other features and advantages of the present invention will become apparent in the following detailed description of the preferred embodiments with reference to the accompanying drawings, in which:

FIG. 1 is a perspective diagram of the disassembled parts of the structure of the present invention.

FIG. 2 is an illustrative diagram of a first preferred embodiment of the present invention.

FIG. 3 is an illustrative diagram of a second preferred embodiment of the present invention.

FIG. 4 is an illustrative diagram of a third preferred embodiment of the present invention.

### DETAILED DESCRIPTION OF THE PREFERRED EMBODIMENTS

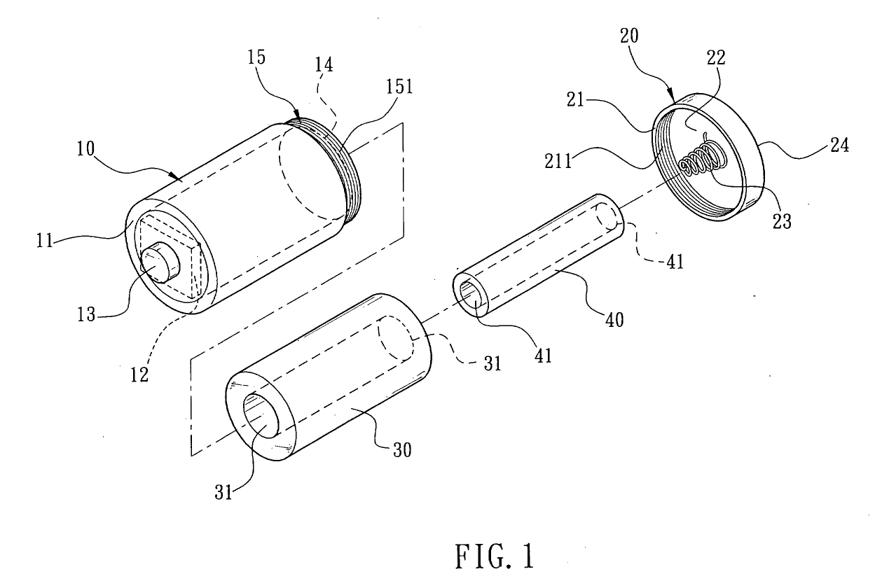

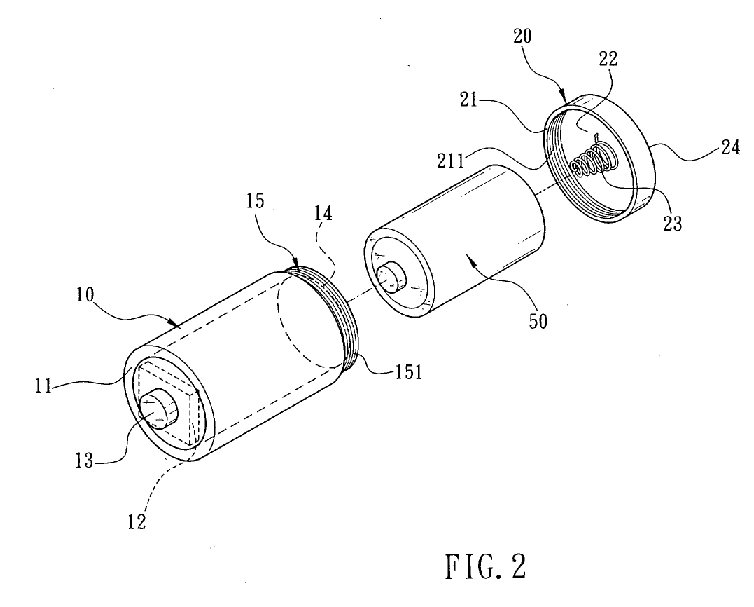

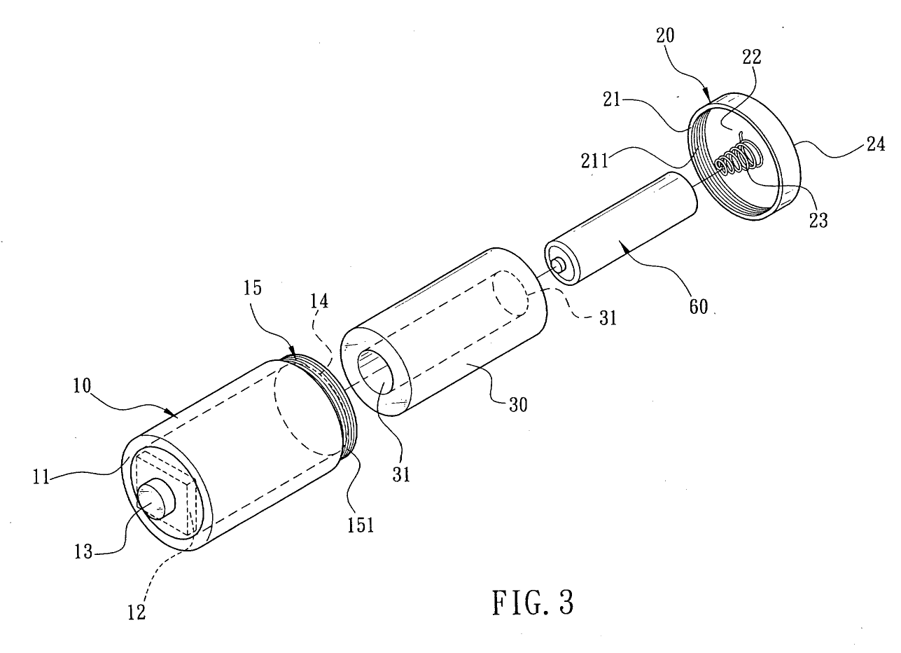

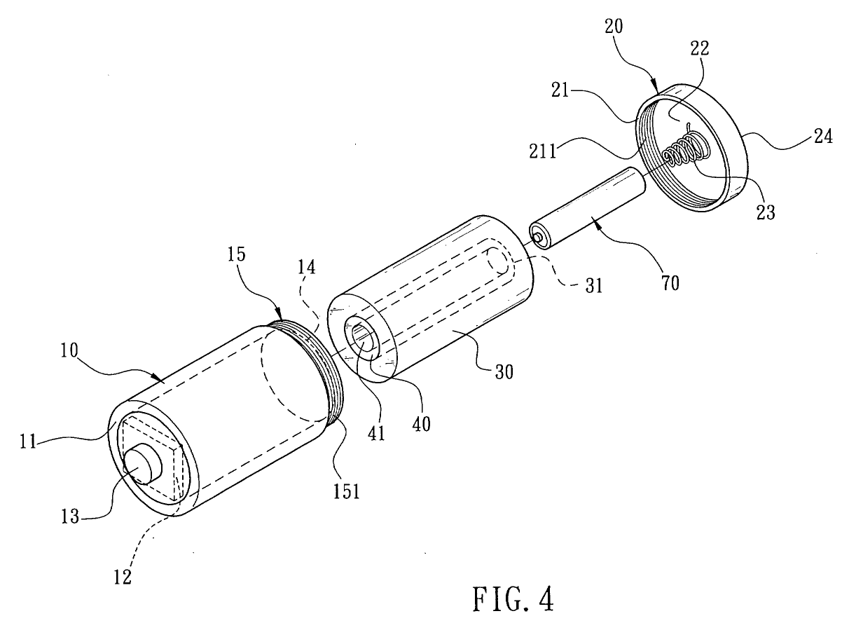

Please refer to FIG. 1 for the first preferred embodiment of the “Battery casing structure adapting different battery specifications” according to the present invention, and the battery casing comprises a main body 10, a cover 20, a first cylindrical battery compartment 30 and a second cylindrical battery compartment 40; the main body 10 (as shown in FIG. 1) is a container substantially in a U-shaped longitudinal section symmetrically along the circumference, and its external diameter is substantially equal to the diameter of the No. 1 Size D battery sold in the market, and its internal diameter is substantially equal to the diameter of the No. 2 Size C Battery 50 (as shown in FIG. 2). However, the size is not limited to this embodiment but can be substituted by its equivalents, and the diameter can accommodate one No. 3 Size AA battery 60 (as shown in FIG. 3) or one No. 4 Size AAA battery 70 (as shown in FIG. 4). The main body 10 has a closed end 11, and the inner wall of the closed end 11 has an electric contact point 12, and such electric contact point is a bracket, however the electric contact point 12 is not limited to this embodiment but can be substituted by its equivalents. The outer wall of the closed end 11 has an anode contact point 13 exposed to couple with the electric contact point 12 for the electric connection with an electric appliance or equipment (not shown in the figure). Further, the main body 10 has an open end 14 on the other end, and a joint section 15 disposed at the top edge of the external circumference.

In FIG. 1, the joint section 15 exactly couples to an open end 21 at one end of the cover 20, such that the main body 10 and the cover 20 are combined to form a battery casing with the volume, length, and diameter exactly the same as those of the No. 1 Size D battery sold in the market. Further, the cover 20 is a container substantially in a U-shaped longitudinal section symmetrically along the direction of circumference, and the other end of the cover 20 is a closed end 22, and the inner wall of such closed end 22 has an electric contact point 23 (as shown in FIG. 1). Such electric contact point 23 is a spring, however the electric contact point 23 is not limited to this embodiment but can be substituted by its equivalents. The outer wall of the closed end 22 has a cathode contact point 24 coupled to the electric contact point 23 on the inner wall for the electric connection with the electric appliance or equipment.

In FIG. 1, the joint of the joint section 15 of the main body 10 and the open end 21 of the cover 20 uses a screw thread 151, 211 for the tight engagement with each other to prevent the objects installed inside from falling out of the main body 10, however such connection method is not limited to this embodiment but can be substitute by its equivalent methods.

In FIG. 1, the internal diameter of the main body 10 can exactly accommodate the first cylindrical battery compartment 30, and the internal diameter of such first cylindrical battery compartment 30 can exactly accommodate one No. 3 Size AA battery 60 (as shown in FIG. 3). Both ends of the first cylindrical battery compartment 30 respectively have an open end 31, so that after the first cylindrical battery compartment 30 is installed into the internal diameter of the main body 10, the electric contact point 12 on the main body 10 and the electric contact point 23 on the cover 20 will not be sheltered due to the two open ends 31, but can electrically connect to the No. 3 Size AA battery 60 sheathed into the internal diameter of the first cylindrical battery compartment 30.

In FIG. 1, the internal diameter of the first cylindrical battery compartment 30 can exactly accommodate the second cylindrical battery compartment 40, and the internal diameter of such second cylindrical battery compartment 40 can exactly accommodate one No. 4 Size AAA battery 70 (as shown in FIG. 4). Both ends of the second cylindrical battery compartment 40 respectively have an open end 41, so that after the second cylindrical battery compartment 40 is installed into the internal diameter of the first cylindrical battery compartment 30, the electric contact point 12 on the main body 10 and the electric contact point 23 on the cover 20 will not be sheltered due to the two open ends 31, but can electrically connect to the No. 4 Size AAA battery 70 sheathed into the internal diameter of the second cylindrical battery compartment 40 (as shown in FIG. 4).

From the description of the foregoing structure, it is obvious that when the No. 2 Size C battery 50 is used as the No. 1 Size D battery, the user just needs to remove the first and second cylindrical battery compartments 30, 40, and directly sheathes the No. 2 Size C battery 50 into the main body 10 (refer to FIG. 2), and then tightly mounts the cover onto the connecting section15 of the main body 10. After a battery casing substantially equal to the size of a No. 1 Size D battery is formed, the battery casing can be applied to the electric appliance or equipment.

If the No. 3 Size AA battery 60 is used as the No. 1 Size D battery (refer to FIG. 3), the user just needs to sheathe the first cylindrical battery compartment 30 into the main body 10 and directly install the No. 3 Size AA battery 60 into the first cylindrical battery compartment 30, and then tightly mount the cover 20 onto the joint section 15 of the main body 10. After a battery casing substantially equal to the size of a No. 1 Size D battery is formed, the battery casing can be applied to the electric appliance or equipment.

Further, if the No. 4 Size AAA battery 70 is used as the No. 1 Size D battery (refer to FIG. 4), the user just needs to sheathe the second cylindrical battery compartment 40 into the first cylindrical battery compartment 30 and directly install the No. 4 Size AAA battery 70 into the second cylindrical battery compartment 40, and then tightly mount the cover 20 onto the joint section 15 of the main body 10. After a battery casing substantially equal to the size of a No. 1 Size D battery is formed, the battery casing can be applied to the electric appliance or equipment.

By means of the battery casing structure adapting different battery specifications according to the present invention, not only can solve the temporary power problem, but also can sheathe a battery of different specifications (such as No. 2 Size C battery 50 and No. 3 Size AA battery 60, etc) into the main body 10 and the cover 20 to avoid direct corrosion to the electronic components in the electric appliance or equipment when a leakage of chemical solution (electrolyte) occurs. Such arrangement can isolate the leaked chemical solution in the main body 10 and the cover 20. Further, the battery casing of the present invention features the low cost, easy operation, and outstanding performance. It is unquestionable that the present invention is a contribution to consumers.

While the present invention has been described in connection with what is considered the most practical and preferred embodiment, it is understood that the invention is not limited to the disclosed embodiments but is intended to cover various arrangements included within the spirit and scope of the broadest interpretation and equivalent arrangements.

What is claimed is:

1. A battery casing structure adapting different battery specifications, comprising:
a main body, substantially in a U-shaped longitudinal section symmetrically along its circumference, having an external diameter substantially equal to the diameter of a No. 1 Size D battery and an internal diameter capable of exactly accommodating a battery of another specification, and one end of said main body being a closed end, and the inner wall of said closed end being an electric contact point, and the outer wall of said closed end protruding an anode contact point coupled to said electric contact point, and the other end of said main body being an open end, and a joint section being disposed at the top edge of the external diameter of said open end,
a cover, substantially in a U-shaped longitudinal section, having an open end at one end of said cover, and said open end being coupled to the joint section of said main body to form a battery casing substantially equal to the size of a No. 1 Size D battery, and the other end of said cover being a closed end, and the inner wall of said closed end having an electric contact point, and the outer wall of said closed end having a cathode contact point coupled to the inner wall of said electric contact point.

2. The battery casing structure adapting different battery specifications of claim 1, wherein said battery is one selected from the collection of a No. 2 Size C battery, a No. 3 Size AA battery, and a No. 4 Size AAA battery.

3. The battery casing structure adapting different battery specifications of claim 1, wherein said main body having an internal diameter exactly sheathing into a first cylindrical battery compartment, and the internal diameter of said first cylindrical battery compartment exactly accommodating a No. 3 Size AA or a No. 4 Size AAA battery, and both ends of said first cylindrical battery compartment respectively having an open end, such that after the first cylindrical battery compartment being sheathed onto the internal diameter of the main body by said two open ends, the electric contact point on said main body and the electric contact point of said cover not being sheltered but electrically coupled to the battery sheathed onto the internal diameter of said first cylindrical battery compartment.

4. The battery casing structure adapting different battery specifications of claim 3, wherein said first cylindrical battery compartment having an internal diameter exactly sheathing into a second cylindrical battery compartment, and said second cylindrical battery compartment having an internal diameter exactly accommodating a No. 4 Size AAA battery, and both ends of said second cylindrical battery compartment respectively having an open end such that after said second cylindrical battery compartment being sheathed into said first cylindrical battery compartment by said two open ends, the electric contact point on said main body and the electric contact point on said cover not being sheltered but electrically coupled to the battery sheathed in the internal diameter of said second cylindrical battery compartment.

5. The battery casing structure adapting different battery specifications of claim 4, wherein said electric contact point at the closed end of said main body is a bracket.

6. The battery casing structure adapting different battery specifications of claim 4, wherein said electric contact point at the closed end of said main body is a spring.

7. The battery casing structure adapting different battery specifications of claim 4, wherein said joint section of the main body and said joint section at the open end of the cover respectively have a screw thread for securely engaging with each other and preventing objects from falling out of said main body.
